(19) United States
(12) Patent Application Publication
(10) Pub. No.: US 2020/0263641 A1
(43) Pub. Date: Aug. 20, 2020

(54) Air Intake Cover with Replaceable and Interchangeable Sections

(71) Applicant: Stevenson T. Blanks, I, Erie, PA (US)

(72) Inventor: Stevenson T. Blanks, I, Erie, PA (US)

(21) Appl. No.: 16/706,119

(22) Filed: Dec. 6, 2019

Related U.S. Application Data
(60) Provisional application No. 62/918,875, filed on Feb. 19, 2019.

(51) Int. Cl. F02M 35/02; F02M 35/10; B01D 46/00; B01D 46/24

(52) U.S. Cl. CPC F02M 35/0203; F02M 35/10321; F02M 35/02483; B01D 46/0004; B01D 46/24; F02M 35/10354

(57) ABSTRACT

A cover for an air intake box that is installed within an engine bay of an automobile and beneath a hood of the automobile is presented. The air intake box comprises an air filter and a housing. The cover comprises a base structure configured to be mounted to the housing. The base structure has an opening sized to allow access to the air filter. A hood is configured to be mounted to the opening, wherein the hood is sized to seal the opening. The hood is configured to uncover the opening and comprises a decorative ornamentation and is replaceable and interchangeable. The base structure and the hood are configured to seal the air intake box when the cover is installed on the housing.

Reference is made to and priority claimed from U.S. Provisional Application No. 62/918,875, filed on Feb. 19, 2019, the disclosure on which is herein incorporated in its entirety by reference.

### BACKGROUND

The present invention relates to after-market replacement covers for existing or original equipment manufacturer (OEM) automobile air intake system housings. Specifically, the present invention is a cover designed to replace an existing top section of an existing bipartite air intake system housing that improves functionality and filter maintenance convenience, as well as introduces interchangeable style elements to the engine bay under the hood of an automobile.

An air intake system supplies air (and its oxygen) to an automobile engine for a combustion process to occur. A good air intake system provides clean and continuous airflow to the engine, which in turn allows the engine to achieve more power and better mileage. Many believe that supplying the engine with cooler air results in improved engine performance in terms of horsepower and mileage, hence, air intake systems are often enclosed in a bipartite housing to shield the internal air filter and flowing air from dirt, and relatively cooler airflow is achieved by positioning the air intake system away from the immediate vicinity of the engine to avoid the intensely heated air surrounding the engine, but still contained within an engine bay and a hood of the automobile. When the hood is open, the top section of the air intake system is directly below the hood, and thus easily accessible by a mechanic or the automobile owner for air filter maintenance.

Many after-market air intake systems are available but most are designed to replace the entire original equipment manufacturer (“OEM”) or another existing installed air intake system in the automobile. Replacement of the entire system is costly, and in many cases, unnecessary. U.S. Pat. No. 6,564,766 B2 (“Ayton”) proposes an improved air box lid to replace an existing upper section of an existing air intake system, fastening the improved lid onto the existing lower box section of the OEM air intake system. However, the Ayton lid fails to address other issues with existing OEM air intake systems, and provides no way of personalizing or adding style to the system's housing, as it is plainly visible inside the engine bay when the automobile hood is lifted, and car aficionados love to show off the contents of the engine bay by propping up the hood so that admirers can see inside. The Ayton lid also lacks features that allow easy access to the interior of the air intake system for maintenance of the air filter and other internal components.

What is needed is a replacement cover for an existing top section designed to be retrofitted to a bottom section of the existing or OEM automobile air intake system installed in an automobile engine bay as an affordable way to upgrade the existing system. What is also needed is a cover with removable and interchangeable sections allowing a consumer to easily personalize the cover of the air intake box system by switching out sections and replacing them with compatible, removable sections with different ornamental designs or features. What is additionally needed is an easily removable cover for the air intake box system, allowing the consumer or mechanic quick and simplified access to an interior of the air intake box system for maintenance of the air filter and other internal components.

### SUMMARY

What is presented is a cover for an air intake box that is installed within an engine bay of an automobile and beneath a hood of the automobile. The air intake box comprises an air filter and a housing. The cover comprises a base structure configured to be mounted to the housing. The base structure has an opening sized to allow access to the air filter. The cover also has a hood configured to be mounted to the opening, wherein the hood is sized to seal the opening, the hood is configured to uncover the opening, the hood comprises a decorative ornamentation, and the hood is replaceable and interchangeable. The base structure and the hood are configured to seal the air intake box when the cover is installed on the housing. In some embodiments the hood seals the opening with a protruding lip that presses against the base structure.

The cover could comprise a filter support insert mounted to the base structure configured to support the air filter. A gasket may be interposed between the base structure and the housing. The hood may be mounted to the opening with a hinge on the base structure. The hood may be mounted to the opening with a pressure fit. The hood may be mounted to the base structure with any one of a clip, a button, a pin, a screw, a bolt, a nut, a two-part clasp, a magnet, and a hasp. In some embodiments, the base structure comprises guide rails around the opening and the hood comprises channels with the hood configured to mount to the opening by slidably mating the guide rails with the channels. In various embodiments, the hood and the base structure are made of ABS heat resistant plastic.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF THE DRAWINGS

The features and advantages of the invention will become apparent from a consideration of the subsequent detailed description presented in connection with accompanying drawings, in which:

FIG. 1 shows the engine of an automobile with an embodiment of air intake cover installed on the air intake box of the automobile;

FIG. 2 is a perspective view of an embodiment of a hinged cover for an air intake system showing a bipartite cover in a closed and secured position;

FIG. 3 is a perspective view of a base structure of FIG. 2;

FIG. 4 is a bottom view of the base structure in FIG. 2;

FIG. 5 is a view of the rear of the filter support insert;

FIG. 6 is a view of the front of the filter support insert of FIG. 5;

FIG. 7 is a bottom view of the hood in FIG. 1 shown detached from the base structure;

FIG. 8 is a perspective view of the hood in FIG. 1 shown detached from the base structure;

FIG. 9 is a view of a compressible rubber gasket;

FIG. 10 is a view of a cone-shaped air filter of a style commonly used with air intake box systems;

FIG. 11 is a top view of FIG. 5, showing the filter support insert with the mounted cone-shaped air filter;

FIG. 12 is a perspective view of the base structure portion of the cover in FIG. 1, shown without the vent hood, and shown with the mounted cone-shaped air filter;

FIG. 13 is a bottom view of FIG. 12, showing the base structure portion with the mounted cone-shaped air filter;

FIG. 14 is a front elevation view of an assembled cover in a hinged embodiment, with cut view lines 15-15 taken through the hood and the base structure;

FIG. 15 is a cut view denoted in FIG. 14 along lines 15-15;

FIG. 16 is a top view of the hinged embodiment;

FIG. 17 is perspective view of the hinged embodiment in with the hood in the open position;

FIG. 18 is a top view of the hinged embodiment showing with several interchangeable decorative hoods;

FIG. 19 is a partial exploded view of another embodiment with a pressure-fitted cover for an enhanced air intake system;

FIG. 20 is a perspective view of an assembled pressure-fitted cover shown in FIG. 19;

FIG. 21 is a partial exploded view of another embodiment with a sliding cover for an enhanced air intake system;

FIG. 22 is a perspective view of an underside of sliding cover of FIG. 21, showing a pair of spaced apart guide extension receiving channels;

FIG. 23 is a rear perspective view of the sliding cover of FIG. 21 showing the pair of guide extension receiving channels;

FIG. 24 is a perspective views of an assembled embodiment of the cover in FIG. 21 showing the sliding motion of the cover over the base structure;

FIG. 25 is a perspective views of an assembled embodiment of the sliding cover in FIG. 21 with a differently decorated cover in the closed position;

FIG. 26 is a partially exploded view of another embodiment with a slotted cover for an enhanced air intake system; and

FIG. 27 is a perspective view of an assembled slotted cover embodiment of FIG. 26.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

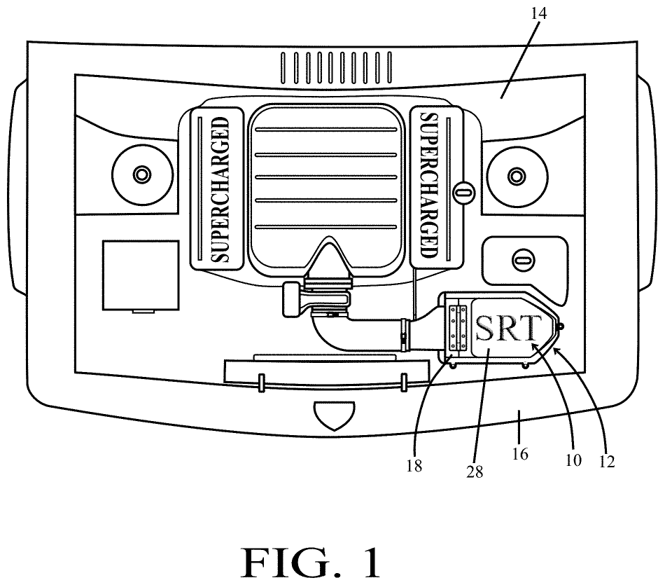

FIG. 1 shows an embodiment of a cover 10 for an air intake box 12 that is installed within an engine bay 14 of an automobile 16 beneath a hood (not shown) of the automobile. Almost all existing air intake systems in automobiles have two sections, an upper (top) section and lower section (bottom). Air intake box 12 systems are usually affixed to the front or side fender well or in some cases near the front bumper of an automobile 16 to place the air intake box 12 system away from the intense hot air of the engine. This allows the engine to receive slightly cooler air. Air intake boxes 12 are typically fully assembled before they are installed into the automobile.

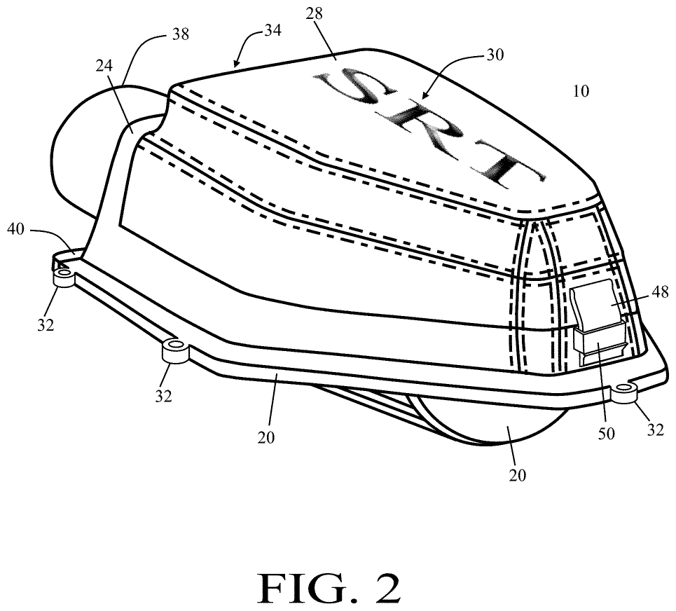

The cover 10 for the air intake box 12 presented herein is an aftermarket part that replaces the manufacturer's air intake box 12 system. As best understood by comparing FIGS. 1 and 2, such air intake boxes 12 typically have at least the following components: a cover 10, a housing 18, a paper air filter 20 that is mounted to an air delivery inlet tube 22, a mass air flow or air intake temperature sensor (not shown), air inlet tube couplers (not shown), and a crank case breather line hose (not shown). Other components may be included depending on the manufacturer. Typically, the elements shown in FIG. 2 completely replace the parts that are included in the automobile. In particular, automobile enthusiasts believe that there is benefit to replacing the manufacturer's air filter with aftermarket improvements such as the cone style air intake filter 20 shown in FIG. 2. Automobile enthusiasts also take pride in the appearance of their vehicles and the appearance of their engines. The cover 10 presented herein offers a way to add style and customization to the air intake box 12.

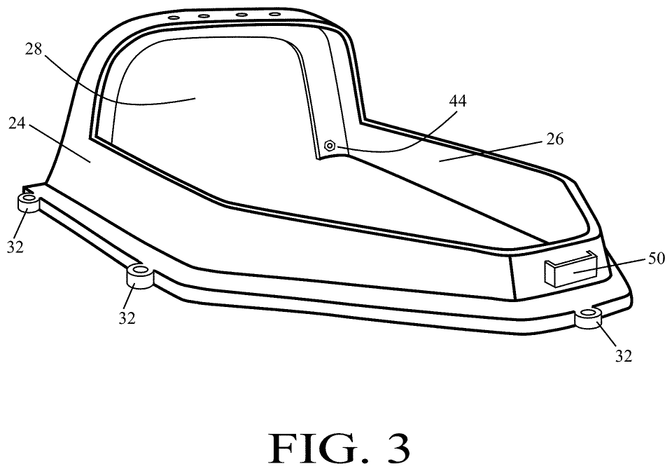

As best seen in FIGS. 2, 3, and 4, the cover 10 comprises a base structure 24 configured to be mounted to the housing 18. The base structure 24 has an opening 26 sized to allow access to the air filter 20. A hood 28 is configured to be mounted to the opening 26. The hood 28 is sized to seal the opening 26. The hood 28 is configured to be removable and to uncover the opening 26 and allow access to the air filter 20. The shape of the base structure 24 defines a second opening to receive a filter support insert 34 that is described in more detail later.

The hood 28 comprises a decorative ornamentation 30. The hood 28 is configured to be easily replaceable and interchangeable so that the user can swap out different decorative ornamentations 30 as desired. The base structure 24 and the hood 28 are configured to seal the air intake box 12 when the cover 10 is installed on the housing 18. The cover 10 may be formed from vacuum form molding ABS heat resistance plastic or some other suitable material.

The decorative ornamentation 30 on the hood 28 may be any kind of decoration that is attractive to the end user. It could be painted, embossed, carved, built-up, formed, sculpted, glued on or any other form that creates an appealing design or pattern on top of the hood 28.

The base structure 24 is mounted to the housing 18 with a series of fastening receivers 32 that match up with corresponding receivers (not shown) on the housing 18. The number, type, and configuration of fastening receivers 32 will depend on the air intake box 12 to which the cover 10 is installed and will vary by automobile manufacture.

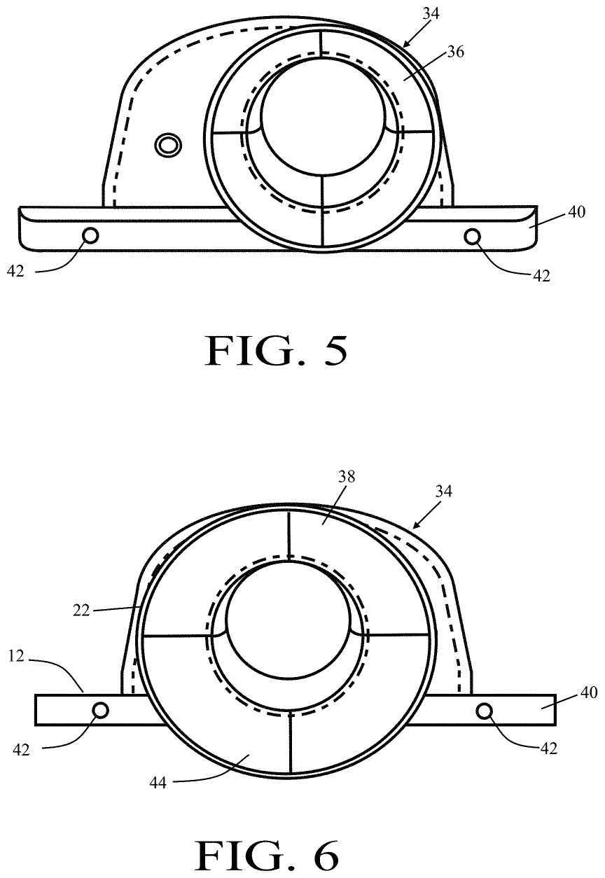

FIGS. 5 and 6 show rear and front views, respectively, of the filter support insert 34. As best understood by comparing FIGS. 1, 2, 5, and 6, the filter support insert 34 is what the air filter 20 is mounted. The filter support insert 34 is also used to mount the cover 10 to the air delivery inlet tube 22. The filter support insert 34 comprises an inlet tube receiving end 36 to which the air delivery inlet tube 22 is mounted and a filter receiving end 38 to which the air filter 20 is mounted. The inlet tube receiving end 36 is sized to mate with the air delivery inlet tube 22 of the engine to which it is installed. The filter receiving end 38 is sized to receive the air filter 20 that is mounted to it. As best understood by comparing FIGS. 2, 3, 4, 5, and 6, a support bar 40 comprising a number of openings 42 is used to mount the base structure 24 to the filter support insert 34. The base structure 24 has openings 44 that correspond to the openings of the filter support insert 34 to receive fasteners (not shown) to secure the two elements together.

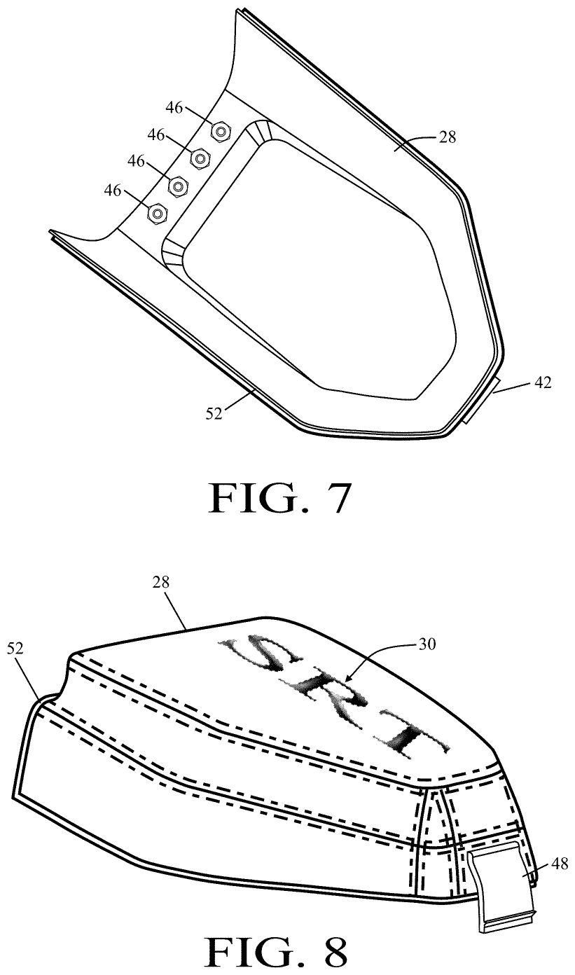

FIGS. 7 and 8 show bottom and perspective views of the hood 28. The hood 28 is sized to fit into the opening 26 in the base structure 24. As explained in more detail later, the hood 28 is configured to receive a series of fasteners 46 which are used to hingeably mount the hood 28 to the base structure 26. As best understood by comparing FIGS. 2, 3, and 8, the front end of the hood 28 has a fastener 48 that mates with a receiver 50 on the base structure 24. Suitable other two-part coupling structures include a pair of magnets, a latch system, clasp system, spring-loaded fastener, hasp, or other bipartite coupling or fastening system. The type of fastener shown in the Figures, along with the hood 28 can be molded as a single piece using ABS heat resistant plastic or other suitable material, or optionally added to the hood 28 later.

As described in more detailed later, the fastener 48 allows the hood 28 to be released from the base structure 24. A protruding lip 52 is located along the circumference of the hood 28. As will be explained in further detail later, the protruding lip 52 allows the hood 28 to seal against the base structure 24.

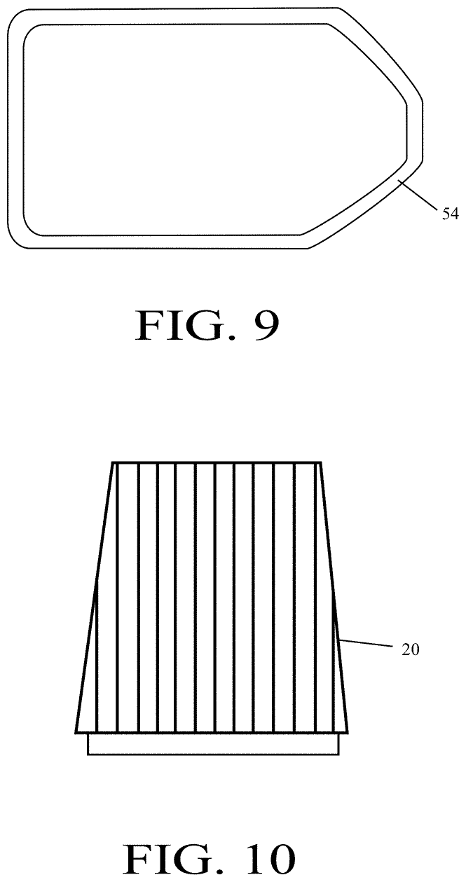

FIG. 9 shows a compressible gasket 54 that is interposed between the base structure 24 and the housing 18. The gasket 54 is made of heat resistant materials. The gasket 54 provides an air-tight seal in the air intake system 12 which improves the performance of the air intake system 12. The gasket 54 may be mounted to the base structure 24 with an adhesive to hold it in place. The FIG. 10 shows a top view of a cone-shaped air filter 20 that is incorporated in the cover 10. The air filter 20 remove impurities from the air before it passes into the automobile's engine via the air intake system 12. The air filter 20 could be any known filter type and may be an inverted-top cone filter, as shown. The air filter 20 may contain materials, such as fibers, foams, or any known natural or synthetic filter material. In various applications, the air filter 20 may contain cotton and polyester folded filter material. The air filter 20 may be removed, washed, and reused as many times as allowed, or may be replaced with new one.

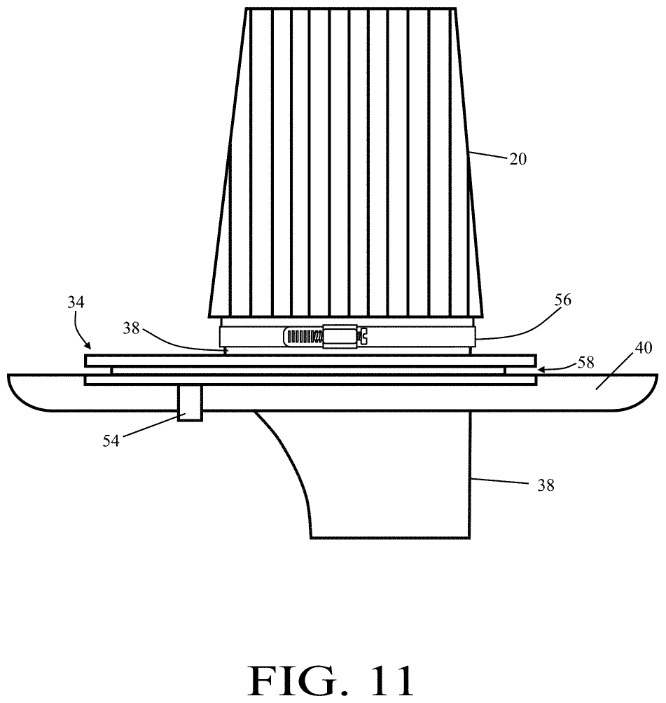

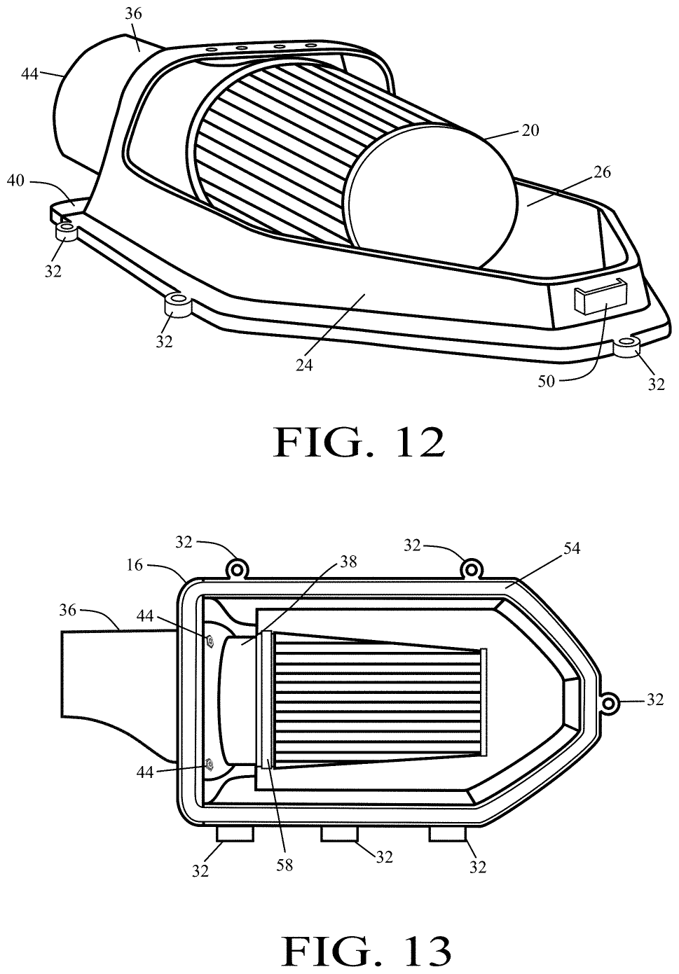

FIG. 11 shows an air filter 20 mounted to the filter receiving end 38 of the filter support insert 34 with a clamp 56. This top view of the filter support insert 34 shows a gap 58 into which outer edge of the base structure 24 can slide into and form a seal between the filter support insert 34 and the base structure 24, as shown in FIGS. 12 and 13. FIG. 13 also shows the gasket 54 installed on the bottom of the base structure 24.

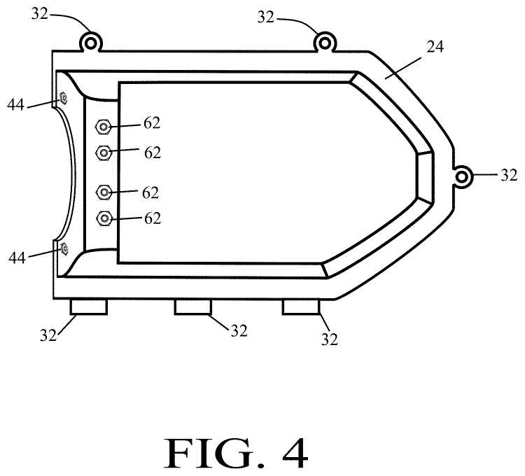

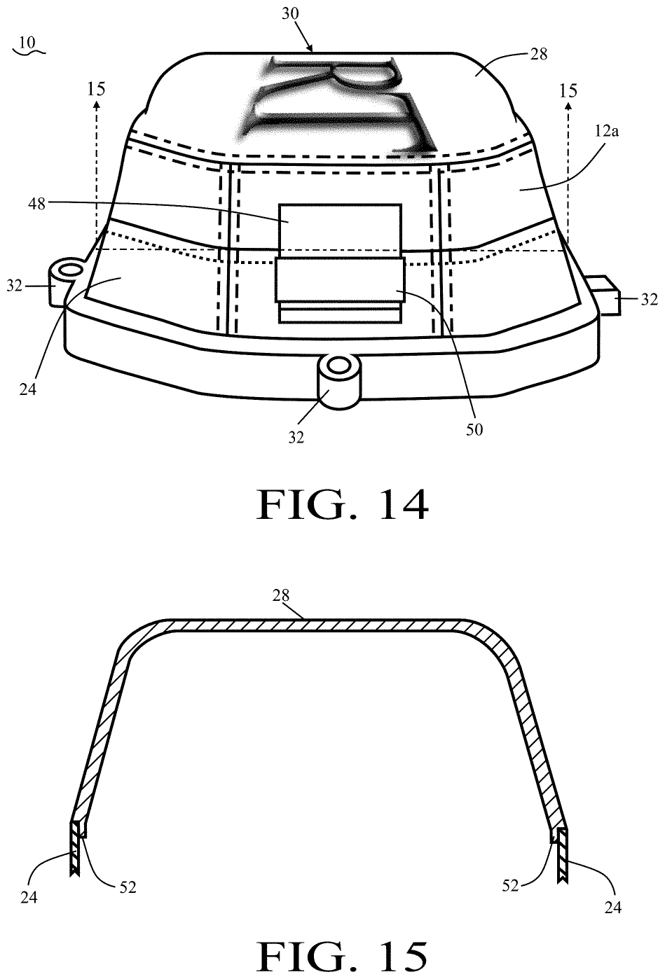

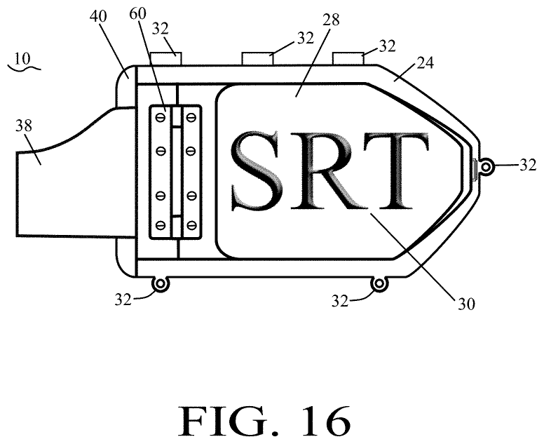

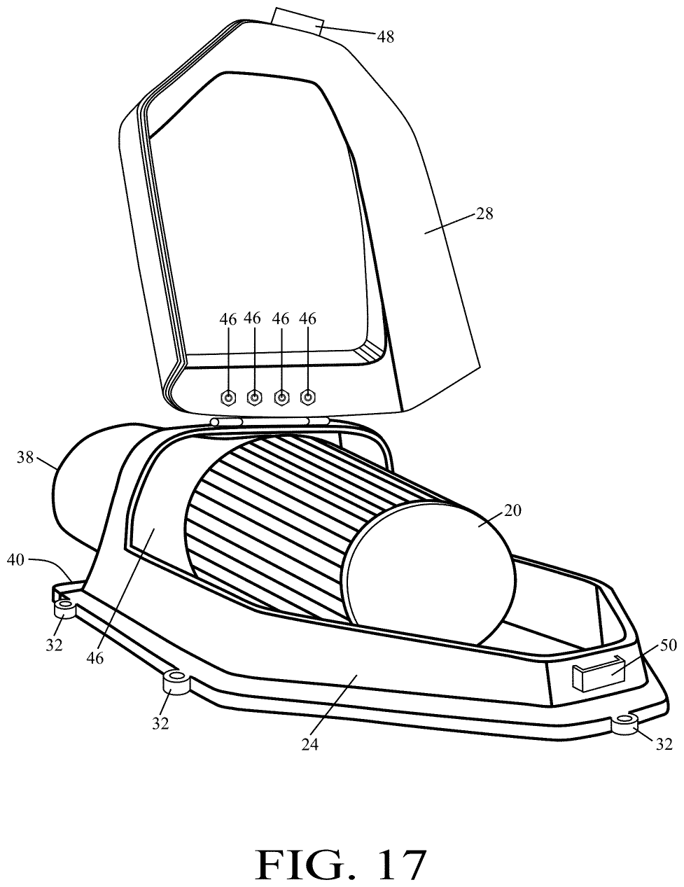

FIG. 14 shows a front elevation view of an assembled cover 10 with the hood 28 installed on the base structure 24. The cross-section in FIG. 15 shows how the protruding lip 52 allows the hood 28 to seal against the base structure 24. FIG. 16 shows a top view of the completed cover 10 in which it can be seen how the hood 28 is installed on the base structure 24 with a hinge 60 that bridges the two parts through the series of fasteners 46 on the hood 28 seen in FIG. 7 and corresponding fasteners 62 on the base structure 24 shown in FIG. 4. As shown in FIG. 17, the hinge 60 allows the hood 28 to be swung open allowing access to the filter 20.

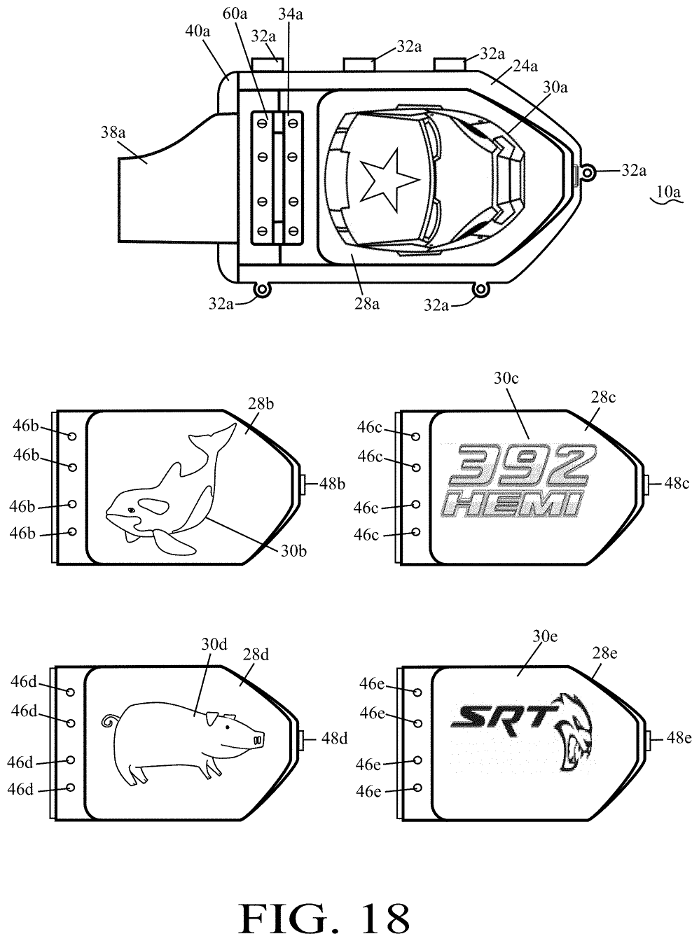

FIG. 18 shows a variation of the cover 10a in which the hood 28a can be swapped out with a different hood 28b, c, d, e with different decorative ornamentations 30b, c, d, e. The hood 28a in this embodiment is mounted to the base structure 24a with a hinge 60a. The hinge 60a allows the easy removal of fasteners 46a on the hood 28a. This allows for the easy customization of the hood 28a.

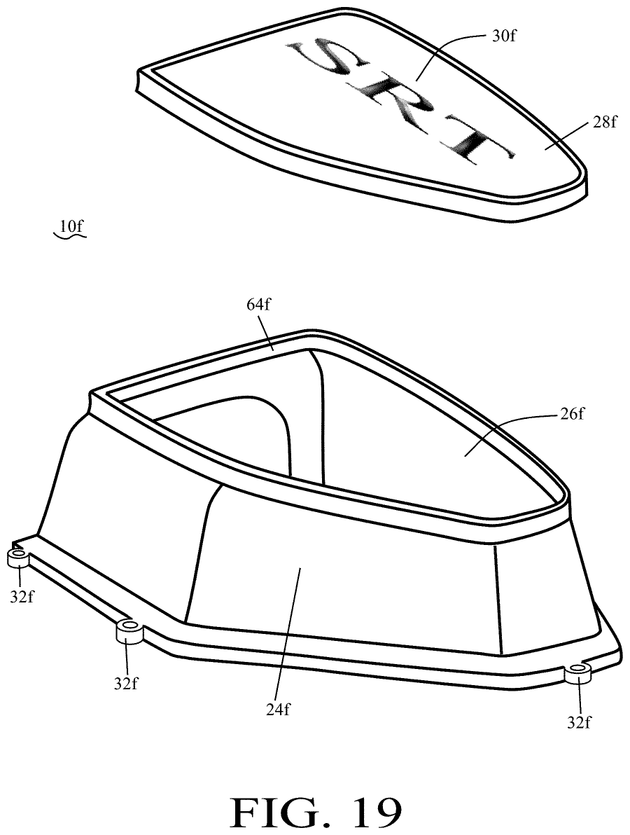

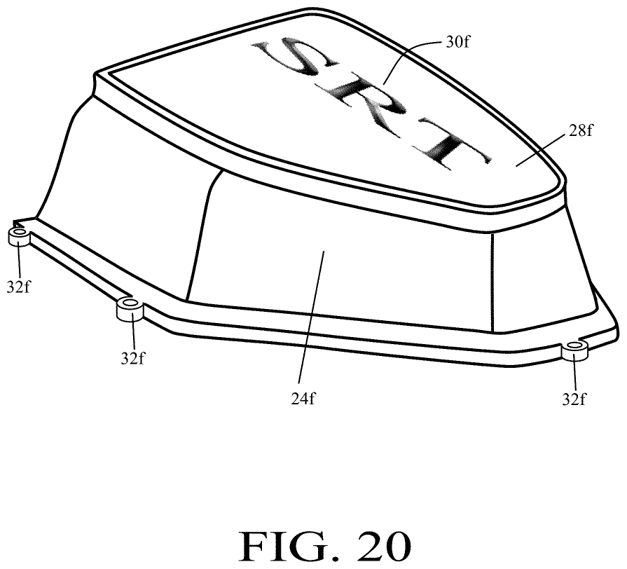

FIG. 19 shows another embodiment of cover 10f for an air intake box in which the hood 28f is mounted to the base structure 24f with a compression fit. In this embodiment, the base structure 24f comprises a circumferential sidewall 64f around the opening 26f. The circumferential sidewall 64f is sized to be a tight fit for the hood 28f to allow the hood 28f to fit snugly within the base structure 24f as shown in FIG. 20. As with the prior embodiments, the hood 28f has a decorative ornamentation 30f that may be swapped out with other hoods with varying ornamentations.

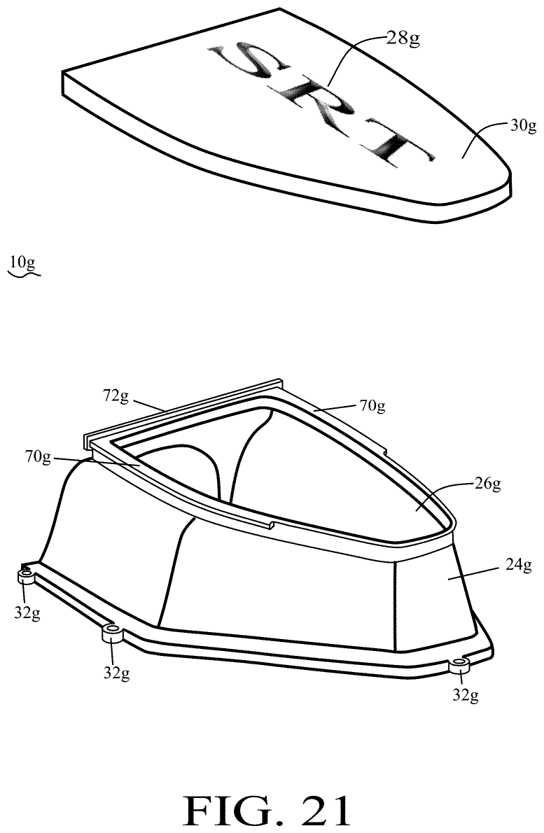

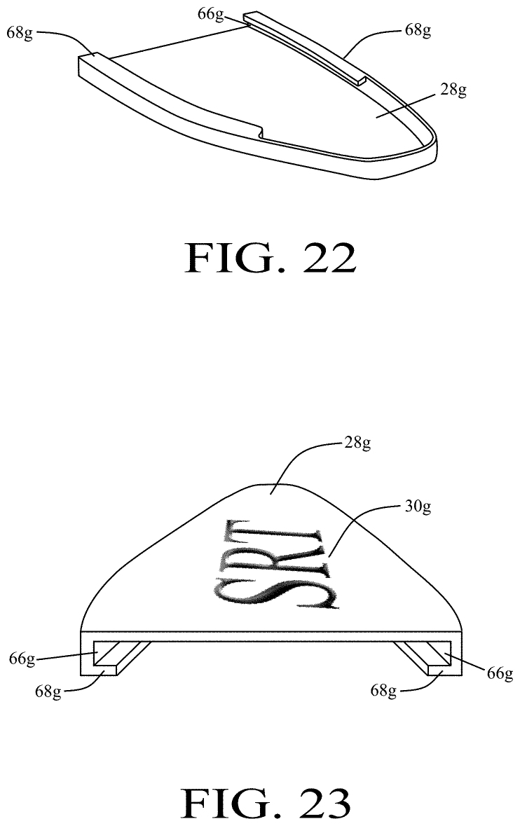

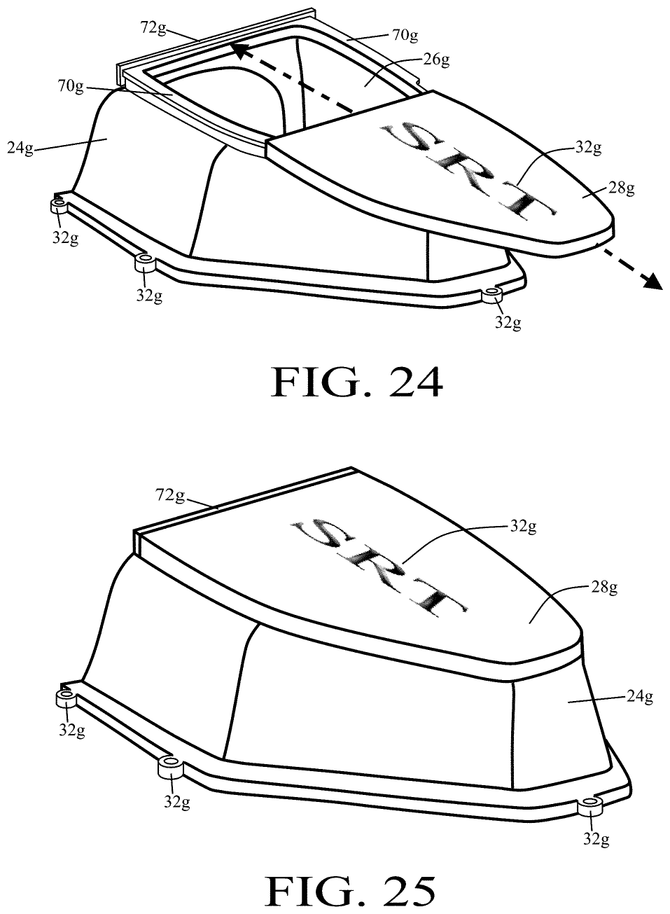

FIGS. 21-25 illustrate another embodiment of the cover 10g that comprises a slidable hood 28g that slidably couples and uncouples with the base structure 24g. The hood 24g has a decorative ornamentation 30g on its upper surface, and is formed with a pair of opposed, spaced apart channels 66g each having a horizontal wall forming a lowermost extension guide 68g. The base structure 24g is formed with a pair of opposed, spaced apart extension guides 70g sized and shaped to be received by the channels 66g, engaging the lowermost extension guides 68g when the hood 28g slides over the opening 26g of the base structure 24g and completely covers the opening 24g when the cover 28g is immediately adjacent a slide stop 72g of the base structure 24g.

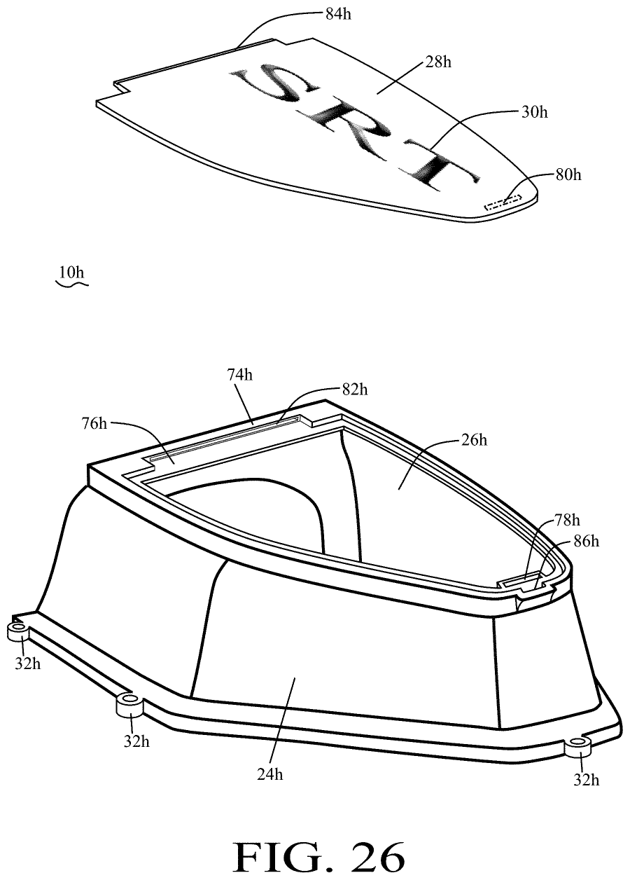

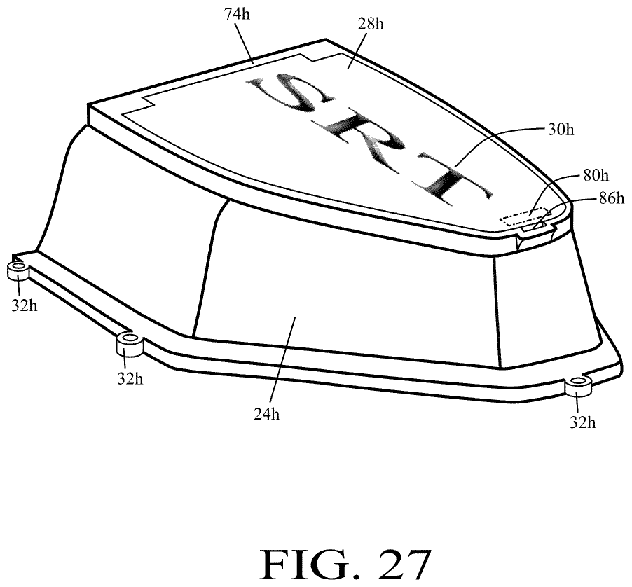

FIGS. 26 and 27 illustrate another embodiment of the cover 10h in which the base structure 24h has a circumferential base 74h formed with a recessed ledge 76h that has a magnet 78h embedded into it. The circumferential base 74h and the recessed ledge 76h together define a receiving area in the opening 26h into which the hood 28h can seat. The hood 28h is sized and shaped to fit snugly into the opening 26h and has a corresponding metallic fastener 80h that is attracted to the magnet 78h. The circumferential base 74h also has a slot opening 82h that is sized to receive a corresponding slot edge 84h in the hood 28h. The hood 28h is installed into the opening 26h by first inserting the slot edge 84h into the slot opening 82h and then dropping the metallic fastener 80h to the magnet 78h. A recessed slot 86h is adjacent the magnet 78h that is sized and shaped to allow a user's finger or other tool to be inserted into it and then grip the hood 28h, applying upwards pressure on the hood 28h to disengage the metallic fastener 80h from the magnet 78h and thus allow the hood 28h to be lifted and disengaged from both the recessed ledge 76h and the slot opening 82h, and removed from the base structure 24h. When the user wants to change a decorative ornamentation 30h of the hood 28h, removing and replacing the hood 28h with a compatible style hood 28h having a different decorative ornamentation 30g is easily accomplished.

It is to be understood that the above-described arrangements are only illustrative of the application of the principles of the present invention. Numerous modifications and alternative arrangements may be devised by those skilled in the art without departing from the scope of the present invention. For instance, the fasteners and fastener systems described herein are easily interchangeable with known fasteners and fastening systems. Heat-resistant fasteners including spring fastener latches, buckles, and even straps can be substituted for at least some of the fasteners and fastening systems shown. It is also possible to permanently affix one side of the hinge to the vent hood or to the base structure and then interchange vent hoods by removing only a single set of fasteners. Even the hinge itself can be modified such that one part is permanently affixed or molded to the base structure, the other part is permanently affixed or molded to the vent hood, and the hinge is then pressure fitted together at a pivot point by snapping and unsnapping the hinge parts together and eliminating fasteners entirely.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A cover for an air intake box that is installed within an engine bay of an automobile and beneath a hood of the automobile, the air intake box comprising an air filter and a housing, the cover comprising:
a base structure configured to be mounted to the housing, said base structure having an opening sized to allow access to the air filter;
a hood configured to be mounted to said opening, wherein said hood is sized to seal said opening, said hood is configured to uncover said opening, said hood comprises a decorative ornamentation, and said hood is replaceable and interchangeable; and
wherein said base structure and said hood are configured to seal the air intake box when the cover is installed on the housing.

2. The cover of claim 1 further comprising a filter support insert mounted to said base structure configured to support the air filter.

3. The cover of claim 1 further comprising a gasket interposed between said base structure and the housing.

4. The cover of claim 1 further comprising said hood is mounted to said opening with a hinge on said base structure.

5. The cover of claim 1 further comprising said hood is mounted to said opening with a pressure fit.

6. The cover of claim 1 further comprising:
said base structure comprises guide rails around said opening;
said hood comprises channels; and
said hood is configured to mount to said opening by slidably mating said guide rails with said channels.

7. The cover of claim 1 further comprising said hood is mounted to said base structure with any one of a clip, a button, a pin, a screw, a bolt, a nut, a two-part clasp, a magnet, and a hasp.

8. The cover of claim 1 wherein at least one of said hood and said base structure are made of ABS heat resistant plastic.

9. The cover of claim 1 in which said hood seals said opening with a protruding lip that presses against said base structure.

10. A hood for a base structure of a cover for an air intake box that is installed in an engine bay of an automobile and beneath a hood of the automobile, the air intake box comprising an air filter and a housing, the base structure configured to be mounted to the housing, the base structure having an opening sized to allow access to the air filter, the hood comprising:
said hood configured to be mounted to the opening, wherein said hood is sized to seal the opening, said hood is configured to uncover said opening, said hood comprises a decorative ornamentation, and said hood is replaceable and interchangeable; and
wherein the base structure and said hood are configured to seal the air intake box when the cover is installed on the housing.

11. The hood of claim 10 further comprising said hood is mounted to the opening with a hinge on the base structure.

12. The hood of claim 10 further comprising said hood is mounted to the opening with a pressure fit.

13. The hood of claim 10 further comprising:
the base structure comprises guide rails around said opening;
said hood comprises channels; and
said hood is configured to mount to the opening by slidably mating said guide rails with said channels.

14. The hood of claim 10 further comprising said hood is mounted to the base structure with any one of a clip, a button, a pin, a screw, a bolt, a nut, a two-part clasp, a magnet, and a hasp.

15. The hood of claim 10 wherein said hood is made of ABS heat resistant plastic.

16. The hood of claim 10 in which said hood seals the opening with a protruding lip that presses against the base structure.
